(19) United States
(12) Patent Application Publication
(10) Pub. No.: US 2026/0364517 A1
(43) Pub. Date: Nov. 19, 2026

(54) LOW PRESSURE DROP SORPTION BED

(71) Applicant: EXXONMOBIL TECHNOLOGY AND ENGINEERING COMPANY, Spring, TX (US)

(72) Inventors: Andrew R. KONICEK, Whitehouse Station, NJ (US); Emre TURKOZ, Lambertville, NJ (US); Mohsen S. YEGANEH, Newtown, PA (US); Arben JUSUFI, Belle Mead, NJ (US); Timothy A. BARCKHOLTZ, Whitehouse Station, NJ (US)

(21) Appl. No.: 19/680,433

(22) Filed: May 18, 2026

Related U.S. Application Data
(60) Provisional application No. 63/808,132, filed on May 19, 2025.

(51) Int. Cl. B01D 53/04

(52) U.S. Cl. CPC B01D 53/0446; B01D 2253/20; B01D 2257/504

(57) ABSTRACT

Systems and methods are provided for reducing or minimizing pressure drop while also reducing or minimizing equipment footprint when performing sorption/desorption processes. Instead of using a single large diameter sorbent bed, a plurality of smaller diameter sorbent bed modules are in a networked arrangement in a vessel that is sufficiently large to allow for some bypass of gas flow around each sorbent bed module. This allows the vessel containing the plurality of sorbent bed modules to functionally serve in the same manner as a single sorbent bed. Similar to a sorbent bed, the vessel containing the sorbent bed modules receives a single input flow and generates a single output flow, but with a substantially smaller cross-section than the corresponding conventional sorbent bed.

### CROSS-REFERENCE TO RELATED APPLICATIONS AND PRIORITY CLAIM

This Non-Provisional Patent application claims priority to U.S. Provisional Patent Application No. 63/808,132, filed May 19, 2025, and titled “Low Pressure Drop Sorption Bed”, the entire contents of which is incorporated herein by reference.

### FIELD

Low pressure drop sorption beds with reduced cross-section are provided along with corresponding methods for using such sorption beds.

### BACKGROUND

Direct air capture (DAC) of CO₂ from air is a technology of continuing interest. DAC is promising as a technology that can allow for reduction or mitigation of CO₂ emissions while avoiding the need for co-locating the CO₂ adsorption system with a point source. However, a variety of challenges remain for implementing commercial scale DAC.

A number of the challenges for DAC are related to the need to reduce or minimize energy costs per volume of air processed. Due to the relatively low concentration of CO₂ in air of roughly 400 vppm, the volume of air that needs to be processed to capture a given amount of CO₂ is rather large. As a result, in order to avoid excessively high energy consumption, the energy consumed per volume of air processed needs to be relatively low. One way to reduce energy consumption is to perform the sorption of CO₂ at whatever the ambient temperature is for air in the local environment. Another way to reduce energy costs is to reduce the pressure drop associated with exposing the air to a sorbent material.

Conventionally, the solution to reducing or minimizing the pressure drop during adsorption of a component from a gas flow is to use a relatively thin sorbent bed. While this is effective, the volume of the sorbent bed is proportional to how much adsorption can be performed before regeneration is needed. Thus, a commercial scale DAC process with a thinner sorbent bed requires a correspondingly larger cross-sectional area for the sorbent bed. While this can be done, the resulting larger cross-sectional area bed requires a larger equipment footprint. This expanded equipment footprint can pose difficulties when attempting to co-locate a DAC process (or other sorption/desorption process) in a setting with constrained space, such as a refinery or chemical plant. Additionally, there are substantial engineering challenges associated with sorbent bed configuration with a small length-to-diameter ratio.

It would be desirable to have alternative systems and methods for reducing or minimizing pressure drop for sorption/desorption applications while also avoiding excessive bed diameter and/or lateral equipment footprint.

U.S. Pat. No. 9,751,039 describes a low pressure drop structure for a particle adsorbent bed. Sorbent material is arranged in at least two stacked layers, with the particle sorbent material being held in place by gas permeable fabric layers. The layers are arranged to provide an inlet face and an outlet face, with the gas being forced to pass through the layers.

U.S. Pat. No. 11,439,927 describes a species extraction apparatus for liquid-based extractions.

U.S. Pat. No. 11,590,447 relates to a porous liquid or a porous liquid enzyme that includes a high surface area solid and a liquid film substantially covering the high surface area solid. The porous liquid or porous liquid enzyme may be contacted with a fluid that is immiscible with the liquid film such that a liquid-fluid interface is formed. The liquid film may facilitate mass transfer of a substance or substrate across the liquid-fluid interface. Methods of performing liquid-based extractions and enzymatic reactions utilizing the porous liquid or porous liquid enzyme are also provided.

U.S. Patent Application Publication 2020/0147543 also relates to a porous liquid or a porous liquid enzyme that includes a high surface area solid and a liquid film substantially covering the high surface area solid.

### SUMMARY

In an aspect, a system for exposing a gas flow to a networked plurality of sorbent modules is provided. The system includes a vessel having at least one gas inlet, at least one gas outlet, a channel volume in fluid communication with the at least one gas inlet, and an exhaust volume in fluid communication with the at least one gas outlet, the channel volume having a channel cross-section height. Additionally, the system includes a plurality of sorbent modules within the vessel, each sorbent module including a sorbent, each sorbent module having a module height that is less than the channel cross-section height, an inlet side of each sorbent module being in fluid communication with the channel volume, an outlet side of each sorbent module being in fluid communication with the exhaust volume, the plurality of sorbent modules comprising three or more sorbent modules. A difference between the module height for a sorbent module and the channel cross-section height is a gap height, a ratio of the gap height for a sorbent module versus the module height for the sorbent module being from 0.0004 to 0.0133.

In another aspect, a method for exposing gas flows to a plurality of sorbent modules is provided. The method includes passing a gas flow containing a first component into a gas inlet of a vessel containing a networked plurality of sorbent modules, a channel volume of the vessel having a channel cross-section height, an inlet side of each of the plurality of sorbent modules being in fluid communication with the channel volume, an outlet side of each sorbent module being in fluid communication with an exhaust volume, each sorbent module including a sorbent, each sorbent module having a module height that is less than the channel cross-section height, the plurality of sorbent modules comprising three or more sorbent modules. Additionally, the method includes passing at least a portion of the gas flow through each sorbent module of the plurality of sorbent modules to form a plurality of module output flows in the exhaust volume. A difference between the module height for a sorbent module and the channel cross-section height is a gap height, a ratio of the gap height for a sorbent module versus the module height for the sorbent module being from 0.0004 to 0.0133.

### BRIEF DESCRIPTION OF THE DRAWINGS

FIG. 1 shows an example of a conventional sorbent bed and a vessel containing a plurality of sorbent beds.

FIG. 2 shows an example of a structure for supporting a reactive liquid.

FIG. 3 shows another example of a structure for supporting a reactive liquid.

FIG. 4 shows an example of an external housing for a structure for supporting a reactive liquid.

FIG. 5 shows an example of a resistor model for determining fluid flow within a vessel containing sorbent beds.

FIG. 6 shows examples of calculations of fluid flow for various configurations of sorbent beds within a vessel.

FIG. 7 shows examples of calculations of fluid flow for various configurations of sorbent beds within a vessel.

FIG. 8 shows examples of calculations of fluid flow for various configuration of sorbent beds within a vessel designed for a 1 MTa CO₂ capture rate for CO₂ capture from a point source.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for reducing or minimizing pressure drop while also reducing or minimizing equipment footprint when performing sorption/desorption processes. Instead of using a single large diameter sorbent bed, a plurality of smaller diameter sorbent bed modules are in a networked arrangement in a vessel that is sufficiently large to allow for some bypass of gas flow around each sorbent bed module. This allows the vessel containing the plurality of sorbent bed modules to functionally serve in the same manner as a single sorbent bed. Similar to a sorbent bed, the vessel containing the sorbent bed modules receives a single input flow and generates a single output flow, but with a substantially smaller cross-section than the corresponding conventional sorbent bed.

Based on appropriate selection of the size of the surrounding vessel relative to the sorbent bed modules, the pressure drop for the gas flow to bypass the sorbent bed modules can be calibrated so that the similar or comparable fractions of the gas flow are processed by each sorbent bed module. This can allow a substantially smaller diameter vessel to perform a sorption/desorption process while still providing a reduced or minimized pressure drop. The selection of the relative sizes for the sorbent bed modules and the surrounding vessel(s) can be performed, for example, using a “resistor” model to determine size differences between the sorbent bed modules and the surrounding vessel(s) that can provide a roughly equal distribution of gas flow to the various sorbent bed modules while also reducing or minimizing the required footprint for the vessel containing the sorbent bed modules.

Conventionally, one method for reducing the pressure drop across a sorbent bed of a given volume is to use a single sorbent bed with a larger cross-sectional area and a smaller thickness. However, when a sorbent bed is of a sufficiently large size, a variety of engineering challenges are created. First, the mechanical and/or structural requirements for supporting such a large sorbent bed can pose difficulties. Additionally, some type of mechanism is needed to distribute the incoming gas flow in an even manner across the large cross-sectional area of the single, larger sorbent bed. Still other problems can be related to the need for corresponding large size fans, pipes, and other supporting equipment to operate the single, larger sorbent bed during a sorption/desorption process.

One alternative to using a single, larger sorbent bed is to have a plurality of sorbent modules that operate in parallel. Using multiple beds in parallel can alleviate some of the engineering challenges related to using a single large bed. However, having several beds operating in a parallel can occupy a similar footprint as a single larger sorbent bed. Additionally, using several parallel beds requires having a mechanism for uniformly splitting the gas flow relatively evenly between the parallel beds while also reducing or minimizing the net pressure drop for the resulting effluent product.

In contrast to conventional methods, systems and methods are provided for organizing a plurality of sorbent bed modules within a single vessel, where the vessel and modules have an appropriate size relationship to reduce or minimize pressure drop while still distributing the gas entering the vessel relatively uniformly across the plurality of sorbent bed modules. This is achieved by using sorbent bed modules that are sized appropriately relative to the vessel, so that the size of the vessel is reduced or minimized while still causing substantially similar amounts of gas to pass through each sorbent bed. The use of a vessel containing networked sorbent bed modules also reduces or minimizes difficulties with piping, as the entire vessel functionally acts as a single “sorbent bed” with regard to delivering a gas flow to the vessel. The distribution of the gas in a relatively uniform manner is achieved based on the sizing of the vessel and the modules within the vessel, thus avoiding the need for complex piping and/or manifolds to manage even distribution of gas flows to a plurality of separate beds that operate in parallel.

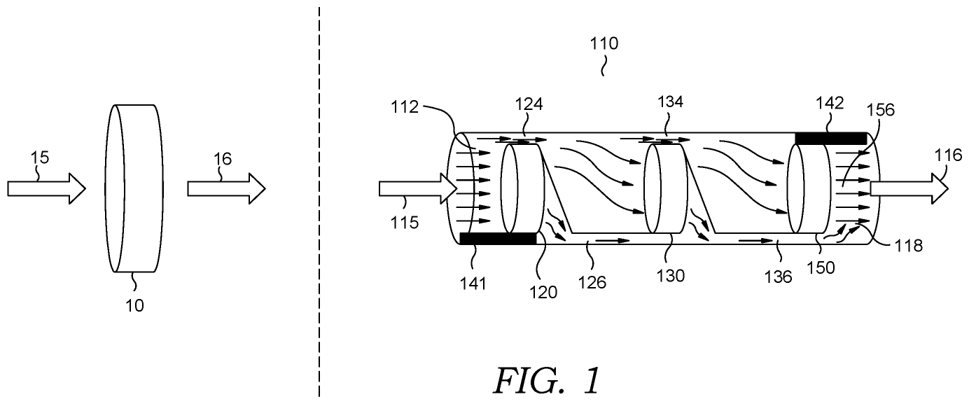

FIG. 1 illustrates the difference in approach between a conventional sorbent bed configuration and a configuration that provides both reduced pressure drop and reduced equipment footprint using a networked arrangement of sorbent modules. The left hand portion of FIG. 1 corresponds to a conventional design. For a conventional design, a sorbent bed 10 of sufficient diameter is used to process a target volume of gas flow 15, while also being sufficiently thin to reduce or minimize the pressure drop between input flow 15 and output flow 16.

The right hand portion of FIG. 1 illustrates a solution to overcome one or more of these engineering challenges. In the right hand portion of FIG. 1, a plurality of sorbent bed modules 120, 130, and 150 are contained within a vessel 110 in a networked arrangement. The input side of each sorbent bed module is in fluid communication with a channel volume 112 of vessel 110. The output side of each sorbent bed module is in fluid communication with an exhaust volume 118 of vessel 110. In the example shown in the right hand portion of FIG. 1, three sorbent bed modules are shown within vessel 110, but it is understood that the plurality of sorbent bed modules can correspond to any convenient number of sorbent bed modules, such as two or more, or three or more, or four or more, or five or more, or six or more, or still higher numbers of sorbent bed modules. As a practical matter, having more than 20 modules, or more than 10 modules, may pose other challenges with regard to equipment size.

For the sorbent bed modules 120, 130, and 150, each module corresponds to a sorbent bed module with a height and/or characteristic dimension so that the sorbent bed module blocks less than all of the cross-sectional area of vessel 110 at the location of the module. Preferably the sorbent bed modules (such as sorbent bed modules 120, 130, and 150) have a cross-sectional shape that is roughly similar to the cross-sectional shape of the channel volume 112 of vessel 110. For example, both the channel volume and the modules can have a roughly circular cross-section, or both can have a roughly elliptical cross-section, or both can have a roughly rectangular (such as square) cross-section. However, this is not required. For example, elliptical sorbent bed modules can be contained within a channel volume of circular cross-section. The vessel can also have any convenient shape relative to the channel volume. For convenience, the channel volume and vessel can roughly similar types of cross-sections, but this is not required.

The size of the sorbent bed modules is selected so that a gap between each module and the wall of the channel volume is sufficient to allow comparable or similar amounts of gas flow (and therefore comparable or similar pressure drops) across each sorbent bed module while still reducing or minimizing the size of the vessel. The relative sizes of the sorbent bed modules and the surrounding vessel can be selected, for example, using a “resistor network model”, that is analogous to the way the total resistance of an arranged network of resistors is calculated. Instead of electrical resistance, the resistor network model is used to determine flow resistance for the modules and associated gaps between the walls of the modules and the surrounding vessel.

After gas flow 115 enters vessel 110, the gas flow first encounters sorbent bed module 120. A portion (typically a majority) of the gas flow 115 bypasses 124 the sorbent bed module 120 via the gap between sorbent bed module 120 and the wall of channel volume 112. It is noted that in the example shown in FIG. 1, the top wall of channel volume 112 is the same as the top wall of vessel 110. It is further noted that in FIG. 1, volume 141 is not accessible to the gas flows. The remaining portion of gas flow 115 passes through sorbent bed module 120 to become outlet flow 126 in exhaust volume 118. The portion of the gas flow that bypasses 124 the sorbent bed module 120 then encounters sorbent bed module 130. A portion of the gas flow bypasses 134 the sorbent bed module 130. The remaining portion passes through sorbent bed module 130 to form outlet flow 136. In the example shown in FIG. 1, the outlet flow 136 is combined with outlet flow 126 as part of a unified output flow 116. In other aspects, separate channels could be present to deliver the outlet flows 126 and 136 as separate output streams as part of output flow 116.

In FIG. 1, three sorbent bed modules are shown, so the portion of the gas flow that bypasses 134 the sorbent bed module 130 will eventually pass through sorbent bed module 150. In the example shown in FIG. 1, there is no bypass channel around sorbent bed module 150. Instead, volume 142 is not accessible to the gas flow.

The sorbent module outlet flows 126, 136, and 156 formed within vessel 110 exit from the exhaust volume 118 of vessel 110 as a combined output flow 116. Thus, vessel 110 functionally acts as a single “sorbent bed”, as a single gas flow input can be used, and a single gas flow output can be generated. Of course, if it is desired to have multiple input and/or output flows, vessel 110 can receive such multiple input flows and/or provide multiple output flows, in a manner similar to how any other single sorbent bed could process such flows.

It is noted that vessel 110 illustrates various types of fluid communication. In vessel 110, interior volume 112 is in direct fluid communication with each sorbent module 120, 130, and 150. This can also be referred to as direct fluid communication with an inlet side of each sorbent module. The interior volume 112 is in indirect fluid communication with exhaust volume 118 via the sorbent modules 120, 130, and 150.

By using a vessel containing a plurality of networked sorbent bed modules that allow for a controlled amount of bypass of a gas flow at each module, the overall pressure drop for processing a gas flow can be substantially reduced while also reducing or minimizing the cross-sectional diameter of the vessel required for housing the sorbent bed modules. This can be advantageous, for example, when retrofitting an existing facility that generates CO₂ to add functionality for CO₂ capture. The available footprint in an existing facility will often be constrained. Avoiding the need for a large diameter sorbent beds can allow a vessel containing thinner networked sorbent bed modules to be used (lower pressure drop) while still accommodating the sorbent bed modules in a limited footprint.

### Bed Design and Resistor Network Model

One way of determining the sizes for the sorbent bed modules relative to the size of the surrounding channel volume is to use a resistor network model. This can allow the footprint of a large sorbent bed to be reduced by sub-dividing the sorbent bed into multiple, smaller sorbent bed modules that are arranged in a suitable configuration. The goal is to have substantially similar flow properties (specifically in terms of pressure drop) while achieving a substantial footprint reduction. In various aspects, this is achieved by placing the modules inside a single, smaller-diameter (or other smaller other cross-section) channel within a vessel. An example involving a cylindrical channel volume is shown in FIG. 1. In other aspects, the channel volume (and/or the vessel) can have any convenient type of cross-section, such as a circular cross-section, a rectangular cross-section, an elliptical cross-section, or a square cross-section. Additionally, a goal is to of the configuration can be to have each module receive a similar or comparable share of the incoming flow, such that each module can roughly absorb and reach capture capacity at substantially the same time.

In some aspects, the amount of gas flow passing through each sorbent bed module can be substantially the same. One way of expressing this can be as a ratio (at steady state) of the gas flow through the module with the lowest gas flow versus the gas flow through the module with the highest gas flow. In such aspects, the ratio (at steady state) of the gas flow through the module with the lowest gas flow relative to the gas flow through the module with the highest gas flow can be 0.75 to 1.0, or 0.90 to 1.0, or 0.95 to 1.0.

Another way of characterizing the configuration can be based on the relative sizes of the sorbent bed modules, the channel volume that contains the sorbent bed modules, and/or the difference in size between the sorbent modules and the channel. In this discussion, the size of the sorbent bed modules and the channel volume is referred to as a “height”. This simplifies describing the relationship between the sorbent modules and the channel volume. For modules and channel volumes that have a circular (or approximately circular) cross-section, the height refers to the diameter of the module or channel volume. For modules and channel volumes that have a square (or roughly square) cross-section, the height refers to the length of a side of the square. More generally, for rectangular modules and channel volumes, the height refers to the length of the longest side of the rectangle. It is noted that for modules and/or channel volumes having an elliptical and/or egg-shaped cross-section, the height of the module or reactor is defined to be the diameter of the circle having the same cross-sectional area as the elliptical or egg-shaped cross-section. Similarly, for any other shape (regular or irregular) that does not readily correspond to one of the shapes specifically recited above, the diameter of the circle with the same cross-sectional area as the shape should be used as the height.

In this discussion, the difference between the height of the channel volume and the height of a module is defined as the height of the “gap” that allows for bypass of the gas flow around a module. In some aspects, a ratio of the height of the gap (h_{gap}) to the height of the module (h_{mod}) can be used to characterize a vessel containing a plurality of modules. In such aspects, the ratio of the height of the gap to the height of the vessel can be from 1:75 to 1:2500, or 1:75 to 1:1500, or 1:150 to 1:2500, or 1:150 to 1:1500. Expressed as a decimal value, the ratio of the height of the gap to the height of the vessel can be 0.0004 to 0.0133, or 0.0006 to 0.0133, or 0.0004 to 0.0067, or 0.0006 to 0.0067.

It is noted that the height of a gap is selected so that the relative flow resistance to gas flow through the gap versus through the module does not become too large. Generally, the height of the gap can be selected so that a ratio of the flow resistance for gas to pass through a module versus the flow resistance to pass through the gap adjacent to the module is 1000 or less. Because the flow resistance of a module to gas flow is dependent on the thickness or width of the module, this means that the target height for the gap can be influenced by the thickness or width of the module adjacent to the gap.

It is further noted that the enclosure channel geometry can be of other cross-sectional geometries, such as an elliptical, square, or rectangular cross-sectional shape. However, for simplicity and without the loss of generality, a circular cross-sectional geometry is used in the following examples for both the sorbent modules and the surrounding vessel in order to illustrate the nature of the invention.

Although this approach is applicable to any type of sorbent bed module, without loss of generality and for illustration purpose of the concept, a SWIRL (structure with infused reactive liquid) type sorbent will be used as an example of a sorbent bed. SWIRL structures can be used in a variety of applications. Some applications correspond to sorption of components from a fluid flow, followed by desorption of the sorbed component to restore the sorption capacity for the next cycle. Sorption of CO₂ from a flue gas flow using an amine-based reactive liquid is an example of this type of application. In other aspects, other types of sorbent bed modules that can be implemented in the configurations described herein include, but are not limited to, packed beds of sorbent particles, including particles based on zeolites and/or metal-organic frameworks; beds containing one or more monoliths having a sorbent supported on the monolith; porous polymeric beds; or any other convenient type of sorbent bed. It is noted that the type of sorbent module for each sorbent module within a vessel can be independently selected. Thus, within a vessel, a first sorbent module can correspond to a packed bed of sorbent particles, while a second bed can correspond to a sorbent supported on one or more monoliths.

To illustrate a flow resistance calculation, the flow resistance for a SWIRL type module is shown here. Similar flow resistance calculations can be performed for other types of conventional sorbent beds. To calculate flow resistance for flow through a SWIRL unit, it is first noted that flow through a SWIRL unit is laminar and can be approximated as Darcy flow, analogous to flow through porous media. In this example, each module has a permeability value, k_{mod}≈2×10⁻⁸ m², and a surface area, A_{mod}. Similarly, each gap between a module and the channel wall also has a permeability, k_{gap}, and a surface area, A_{gap}. As defined by Darcy's law, the flow resistance of each module is defined as R_{mod}=(k_{mod}A_{mod})⁻¹, and the resistance of the gap as R_{gap}=(k_{gap}A_{gap})⁻¹. Using a resistor network approximation, these resistance values can be placed in the proper networked arrangement configuration following the flow direction in order to determine the total module resistance as well as the relative pressure drop, and flow fraction, through each module.

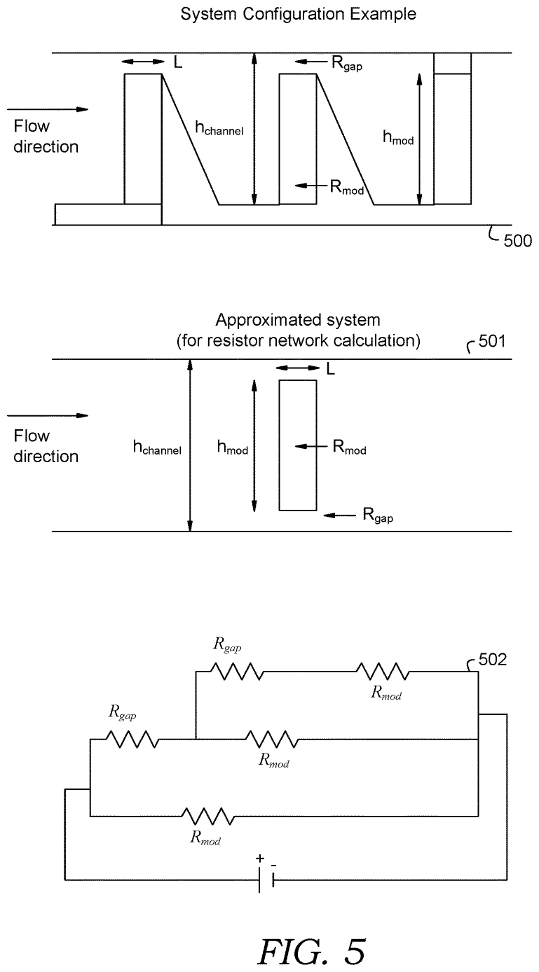

The top diagram in FIG. 5 shows a schematic 500 of the sequential placement of modules inside a cylindrical channel. The bottom of FIG. 5 shows a corresponding resistor network model 502. The middle diagram 501 illustrates how a real system can be approximated in order to simplify the resistance calculation while still providing substantially the same results.

Schematic 500 in FIG. 5 shows modules placed sequentially in an axially symmetric domain. In schematic 500, each module has a length L and module diameter h_{mod}. A goal of the configuration can be to select the module diameter so that each module gets a roughly equal share of the incoming flow. The permeability and surface area of the gap and the module contribute to their effective resistance, R_{gap} and R_{module}, respectively. In addition to the height of module, schematic 500 also shows the height of the channel volume h_{channel}.

The middle diagram 501 shows an approximation that is used to simplify modeling of the flows within a system, in order to allow for comparison of the results from computation fluid dynamics calculations with the values determined according to a resistor model. It is noted that in the real system depicted in schematic 500, the sorbent modules are not centered within the channel volume. Instead, the sorbent module is in contact with the bottom portion of the channel volume while a gap is present between the channel volume and the sorbent module at the top of the module. From a practical standpoint, this type of configuration is used so that the output from the sorbent module can be passed into the separate exhaust volume. However, for computational purposes, substantially the same results can be achieved using a simplified model where the bed is centered within the channel volume. This type of simplified model is shown as diagram 501. Although the real system has a gap that is only one side of a sorbent module while the simplified model has an annular gap, based on performing computational fluid dynamic simulations, using the simplified model in place of a model more similar to the real system resulted in only minimal differences for the predicted gap size.

Resistor network 502 shows how the gap resistance, R_{gap}, and module resistance, R_{mod}, are placed in an networked arrangement where appropriate for the sequential placement of modules in a channel as shown in schematic 500.

### Example—Use of CFD to Verify Resistor Network Model and Design Approach

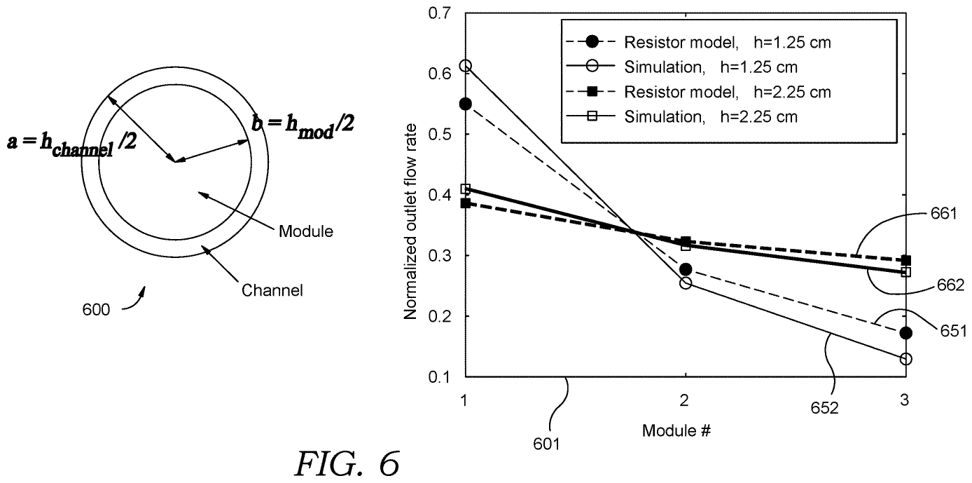

The resistor network approach is verified with the results produced by computational fluid dynamics (CFD) simulations. For this verification, an axially symmetric geometry was used where three concentric modules are placed inside a cylinder. The module and the channel have cross-sections as shown in FIG. 6. The flux through the gap in this case can be calculated analytically as Q_{gap},

$${Q}_{gap} = \frac{π}{8 μ} \frac{Δ P}{L} [ {a}^{4} - {b}^{4} - \frac{{( {a}^{2} - {b}^{2} )}^{2}}{ln ( a / b )} ] = \frac{{k}_{gap} {A}_{gap}}{μ L} Δ P , \qquad ( 1 )$$

where

$$a = \frac{{h}_{channel}}{2} and b = \frac{{h}_{mod}}{2}$$

are defined as shown in FIG. 6, ΔP is the pressure drop across the gap, μ is the gas viscosity, and L is the gap length. It is noted that Equation (1) corresponds to equation 6.54 in B. R. Munson et al., “Fundamentals of Fluid Mechanics”, 7^{th} ed. Equation (1) allows the gap resistance R_{gap}=(k_{gap}A_{gap})⁻¹ to be calculated analytically for a given geometry for this module arrangement. The resistance for a gas passing through a module can also be calculated as described above.

It is noted that, in practice, the sorbent beds will be offset from the center line within the vessel containing the sorbent beds, so that the output flow from the sorbent beds can be passed into a second volume that does not mix with the volume containing the input flow. Although FIG. 6 shows an example with concentric modules inside the cylindrical channel, it is understood that the shape of the gap has minimal impact on the fluid flow characteristics. Thus, the use of concentric modules, where an annular gap surrounds the sorbent bed, is still representative of configurations where the sorbent beds are offset from the center of the module.

A two-dimensional, axially-symmetric computational fluid dynamics (CFD) simulations were performed for the configuration with three modules shown in FIG. 6. In the simulations, air was used as the fluid, with a fluid viscosity of roughly 1.5×10⁵ m²/s. The CFD calculations were performed to identify configurations with an upper limit for the pressure drop across the vessel of 50 mbar or less, preferably 10 mbar or less, or 5 mbar or less, such as down to substantially no pressure drop across the vessel. The simulations were performed using a commercially available CFD software package. Modules in this example have equal diameter h_{mod}=4.9075 m. FIG. 6 shows the comparison of the resistor network result with the simulation results for two different gaps, Δh=h_{channel}/2−h_{mod}/2, of either 1.25 cm or 2.25 cm. Line 651 corresponds to the resistor network model for a gap of 1.25 cm. Line 652 corresponds to the CFD simulation for a gap of 1.25 cm. Line 661 corresponds to the resistor network model for a gap of 2.25 cm. Line 662 corresponds to the CFD simulation for a gap of 2.25 cm. In FIG. 6, the flow rate through each bed is shown. If the flow rate through each bed was identical (as would occur if the gaps were sufficiently large), the normalized flow rate for each bed would be 0.33, corresponding to having an equal one-third of the flow through each bed.

In FIG. 6, the resistor model results show good agreement with the simulation results. The former seems to be biased toward a more equal flow distribution while the simulation results indicate a slight inhomogeneity of the flow distribution across the different modules. However, both models demonstrate the same trend when the gap is increased: the flow distribution starts to deviate from equal distribution for gaps around 2 cm or less, whereas any gap greater than 2 cm in the three-bed configuration results in nearly equal flow distribution through each module.

For the results at a gap of 2.25 cm, both the resistor model and the simulation show that the normalized flow through the first bed is roughly 0.4, while the normalized flow through the third (final) bed is roughly 0.3. This corresponds to a ratio of the lowest gas flow through a bed to the highest gas flow through a bed at steady state of 0.75.

It is noted that based on the module size of 4.9075 m, a roughly 2 cm gap corresponds to a ratio of h_{gap} to h_{mod} of roughly 1:250, or 0.004.

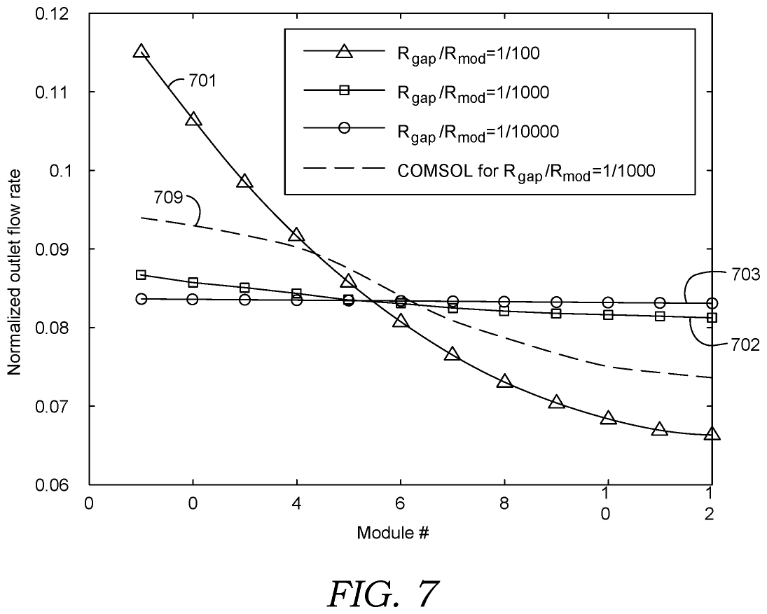

It is possible to extend the use of the resistor model to an arbitrary number of modules. FIG. 7 presents the extension of the model to a twelve-module configuration. FIG. 7 shows normalized gas flow through each of twelve sorbent modules. However, instead of showing the normalized gas flows at various values for the height of the gap, FIG. 7 shows the normalized gas flows for various ratios of the flow resistance in a gap (R_{gap}) versus the resistance for a sorbent module (R_{mod}). In FIG. 7, line 701 corresponds to

$$\frac{{R}_{gap}}{{R}_{mod}} = \frac{1}{100} ,$$

as calculated using the resistor model. Line 702 corresponds to

$$\frac{{R}_{gap}}{{R}_{mod}} = \frac{1}{1000} ,$$

and line 703 corresponds to

$$\frac{{R}_{gap}}{{R}_{mod}} = \frac{1}{10000} .$$

Additionally, line 709 corresponds to

$$\frac{{R}_{gap}}{{R}_{mod}} = \frac{1}{1000} ,$$

as calculated using a CFD calculation in the commercial modeling package.

As shown in FIG. 7, the deviation from equal flow distribution among the various modules becomes noticeable at about

$$\frac{{R}_{gap}}{{R}_{mod}} = \frac{1}{1000} .$$

It is noted that a module diameter of h_{mod}=4.8 m and a channel diameter of h_{channel}=5.1 m corresponds to

$$\frac{{R}_{gap}}{{R}_{mod}} = \frac{1}{10000} ,$$

which forms a sufficiently large gap for equal flow distribution. This corresponds to a gap height of 30 cm, a module height of 480 cm, with a ratio of the gap height (h_{gap}) to the height of the module (h_{mod}) of 0.3/4.8, or 0.063.

### SWIRL Structures

In various aspects, a structure suitable for use as the structure for a Structure with Infused Reactive Liquid (SWIRL) corresponds to a structure where a suitable liquid film is able to infuse into, wet, and stably cover a high surface area portion of the structure. This high surface area portion of the structure can correspond to at least a portion of one or more solid surfaces that are rough, porous, roughened, and/or textured surface to provide a high surface area. The liquid film can infuse into, wet, and stably cover the high surface area portion if the high surface area portion has sufficient surface roughness, large surface area, and physical and/or chemical affinity for the liquid film. The degree of roughness and/or texture required to stably cover the high surface area portion of the structure will depend on the formulation of the liquid film and the chemical composition of the surface of the high surface area portion of the structure. Examples of structures that can have sufficiently high surface area in at least a portion of one or more solid surfaces include, but are not limited to, 3D printed structures.

The roughness of a surface of the high surface area portion is defined as the ratio between the actual area of a surface and the projected area of the surface, where the projected area corresponds to the maximum area obtained if the surface is projected onto a 2-dimensional plane. By definition, when the roughness equals 1.0, a surface is completely flat, as the actual area and projected area are identical. In various aspects, the roughness of the surface in the high surface area portions can be 1.01 is at least 1.01, at least 1.1, at least 1.2, at least 1.3, at least 1.4, at least 1.5, at least 1.6, at least 1.7, at least 1.8, at least 1.9, at least 2, at least 2.25, at least 2.5, at least 2.75, at least 3, at least 3.5, at least 4, at least 4.5, at least 5, or more, such as up to 10 or possibly still higher.

In certain aspects, the high surface area portion includes at least one of a rough surface, a textured surface, or both. Thus, a high surface area portion may be prepared with a surface that has a matrix of solid features or a rough surface. The matrix of solid features may include microstructures and/or nanostructures that protrude or extend from the surface of the high surface area portion. The texture (e.g., the micro-structures and/or nano-structures) may be applied to the surface of the high surface area portion, or the texture may be formed as part of a 3D printing process. During operation, the reactive liquid substantially covers the high surface area portion.

The solid features (e.g., micro-structures and/or nano-structures) may have an average characteristic dimension (i.e., length for roughly rod-shaped objects, thickness, depth, height, or combinations thereof) of 0.1 μm to 1000 μm (e.g., 1 μm to 200 μm or 10 μm to 50 μm). For example, the average characteristic dimension of the solid features may be 0.1 μm to 1000 μm, 0.1 μm to 500 μm, 0.1 μm to 300 μm, 0.1 μm to 100 μm, 0.1 μm to 50 μm, 25 μm to 1000 μm, 25 μm to 500 μm, 25 μm to 300 μm, 25 μm to 100 μm, 75 μm to 1000 μm, 75 μm to 500 μm, 75 μm to 300 μm, 150 μm to 1000 μm, 150 μm to 500 μm, 150 μm to 300 μm, 300 μm to 1000 μm, 300 μm to 500 μm, or 400 μm to 1000 μm. In any aspect or embodiment described herein, the solid features (e.g., microstructures and/or nano-structures) are arranged with average spacing of 0.1 μm to 500 μm (e.g., 5 μm to 200 μm or 10 μm to 30 μm) between adjacent solid features. For example, the average space between solid features may be 0.1 μm to 500 μm, 0.1 μm to 200 μm, 0.1 μm to 30 μm, 1 μm to 500 μm, 1 μm to 200 μm, 1 μm to 30 μm, 5 μm to 500 μm, 5 μm to 200 μm, 5 μm to 30 μm, 10 μm to 500 μm, 10 μm to 200 μm, 25 μm to 500 μm, 25 μm to 200 μm, 50 μm to 500 μm, 50 μm to 200 μm, 100 μm to 500 μm, 100 μm to 200 μm, 150 μm to 500 μm, 150 μm to 200 μm, 200 μm to 500 μm, 250 μm to 500 μm, 300 μm to 500 μm, or 350 μm to 500 μm.

The texture or roughness may be imparted through extrusion, electrospinning, blow-molding of a mixture of materials (e.g., glass, polyethylene, a continuous polymer blend, or mixture of a polymer and particles), or additive manufacturing such as 3D printing laser metal deposition. One of the materials may be subsequently dissolved, etched, melted, or evaporated away, leaving a textured, and/or rough surface behind. The texture or roughness may be imparted by mechanical roughening (e.g., tumbling with an abrasive), spray-coating or polymer spinning, deposition of particles from solution (e.g., layer-by-layer deposition, evaporating away liquid from a suspension of liquid and particles), and/or additive manufacturing such as 3D printing laser metal deposition.

In any embodiment herein, the surface of the high surface area portion may be roughened.

In any aspect or embodiment described herein, the high surface area portion has a surface area of about 0.001 m²/g to 45 m²/g, about 0.001 m²/g to 40 m²/g, about 0.001 m²/g to 35 m²/g, about 0.001 m²/g to 30 m²/g, about 0.001 m²/g to 25 m²/g, about 0.001 m²/g to 20 m²/g, about 0.001 m²/g to 15 m²/g, about 0.001 m²/g to 10 m²/g, about 0.001 m²/g to 5 m²/g, about 0.001 m²/g to 1.0 m²/g, about 0.01 m²/g to 45 m²/g, about 0.01 m²/g to 40 m²/g, about 0.01 m²/g to 35 m²/g, about 0.01 m²/g to 30 m²/g, about 0.01 m²/g to 25 m²/g, about 0.01 m²/g to 20 m²/g, about 0.01 m²/g to 15 m²/g, about 0.01 m²/g to 10 m²/g, about 0.01 m²/g to 5 m²/g, about 0.01 m²/g to 1.0 m²/g, about 0.1 m²/g to about 45 m²/g, about 0.1 m²/g to about 40 m²/g, about 0.1 m²/g to about 35 m²/g, about 0.1 m²/g to about 30 m²/g, about 0.1 m²/g to about 25 m²/g, about 0.1 m²/g to about 20 m²/g, about 0.1 m²/g to about 15 m²/g, about 0.1 m²/g to about 10 m²/g, about 0.2 m²/g to about 45 m²/g, about 0.2 m²/g to about 40 m²/g, about 0.2 m²/g to about 35 m²/g, about 0.2 m²/g to about 30 m²/g, about 0.2 m²/g to about 25 m²/g, about 0.2 m²/g to about 20 m²/g, about 0.2 m²/g to about 15 m²/g, about 0.2 m²/g to about 10 m²/g, about 0.5 m²/g to about 45 m²/g, about 0.5 m²/g to about 40 m²/g, about 0.5 m²/g to about 35 m²/g, about 0.5 m²/g to about 30 m²/g, about 0.5 m²/g to about 25 m²/g, about 0.5 m²/g to about 20 m²/g, about 0.5 m²/g to about 15 m²/g, about 0.5 m²/g to about 10 m²/g, about 5 m²/g to about 45 m²/g, about 5 m²/g to about 40 m²/g, about 5 m²/g to about 35 m²/g, about 5 m²/g to about 30 m²/g, about 5 m²/g to about 25 m²/g, about 5 m²/g to about 20 m²/g, about 5 m²/g to about 15 m²/g, about 10 m²/g to about 45 m²/g, about 10 m²/g to about 40 m²/g, about 10 m²/g to about 35 m²/g, about 10 m²/g to about 30 m²/g, about 10 m²/g to about 25 m²/g, about 10 m²/g to about 20 m²/g, about 15 m²/g to about 45 m²/g, about 15 m²/g to about 40 m²/g, about 15 m²/g to about 35 m²/g, about 15 m²/g to about 30 m²/g, about 15 m²/g to about 25 m²/g, about 20 m²/g to about 45 m²/g, about 20 m²/g to about 40 m²/g, about 20 m²/g to about 35 m²/g, about 20 m²/g to about 30 m²/g, about 25 m²/g to about 45 m²/g, about 25 m²/g to about 40 m²/g, about 25 m²/g to about 35 m²/g, about 30 m²/g to about 45 m²/g, about 30 m²/g to about 40 m²/g, or about 35 m²/g to about 40 m²/g.

In some embodiments, the liquid film has a thickness from the bottom of the roughness or the texture to the top surface of the liquid film no greater than 1400 μm. For example, the thickness can be 10 μm to 1400 μm, or 10 μm to 1000 μm, or 10 μm to 1000 μm, or 100 μm to 1400 μm, or 100 μm to 100 μm.

### Example of Process Application—CO₂ Sorption and Desorption

Sorption and desorption of a component from a gas flow is an example of a process that can be performed using a reactive liquid supported by a SWIRL structure. An amine-based sorbent is an example of a suitable sorbent that can be used as a reactive liquid.

A sorption/desorption cycle can include a series of steps. As an example, a sorbent can be located in a sorbent environment. One type of step that is always included is a sorption step, where the sorbent is exposed to a gas so that one or more components in the gas can be sorbed by the sorbent. In various aspects, during a sorption step, sorption (such as absorption or adsorption) of gas component can be performed at a temperature in the sorbent environment between −10 °C to 95 °C, or −10 °C to 70 °C, or −10 °C to 45 °C, or −10 °C to 25 °C, or 0 °C to 95 °C, or 0 °C to 70 °C, or 0 °C to 45 °C, or 0 °C to 25 °C. The temperature in a sorbent environment during a sorption step can be characterized based on measuring the temperature of the gas exiting from the sorbent environment at the end of the sorption step. It is noted that the temperature in a sorbent environment may vary during a sorption step and/or a desorption step. Depending on the aspect, the sorption step can be performed at roughly ambient pressure, or at a pressure greater than ambient. In various aspects, the pressure in the sorbent environment during the sorption step can be 90 kPa-a to 150 kPa-a, or 90 kPa-a to 120 kPa-a, or 100 kPa-a to 150 kPa-a, or 110 kPa-a to 150 kPa-a. The pressure in the sorbent environment during the sorption step can be characterized based on the pressure of the gas exiting from the sorbent environment.

Another type of step that is always present is a desorption step. During a desorption step, desorption of a sorbed component can be performed at a temperature in the sorbent environment between 20 °C to 150 °C, or 20 °C to 100 °C, or 20 °C to 50 °C, or 35 °C to 150 °C, or 35 °C to 100 °C, or 50 °C to 150 °C, or 50 °C to 100 °C, or 70 °C to 150 °C, or 70 °C to 100 °C. The temperature in a sorbent environment during a desorption step can be measured based on the temperature of the gas exiting from the sorbent environment at the end of the desorption step. In addition to higher temperature, in some aspects desorption of a sorbed component can be facilitated by performing desorption at a lower pressure than the sorption step. In various aspects, the pressure during the desorption step can be 1.0 kPa-a to 150 kPa-a, or 1.0 kPa-a to 110 kPa-a, or 10 kPa-a to 150 kPa-a, or 30 kPa-a to 150 kPa-a, or 50 kPa-a to 150 kPa-a, or 10 kPa-a to 110 kPa-a, or 30 kPa-a to 110 kPa-a, or 50 kPa-a to 110 kPa-a. In some aspects, the pressure during desorption can correspond to a pressure below ambient. In such aspects, the pressure during desorption can be 1.0 kPa-a to 90 kPa-a, or 1.0 kPa-a to 70 kPa-a, or 1.0 kPa-a to 50 kPa-a, or 10 kPa-a to 90 kPa-a, or 10 kPa-a to 70 kPa-a, or 10 kPa-a to 50 kPa-a, or 30 kPa-a to 90 kPa-a, or 30 kPa-a to 70 kPa-a, or 50 kPa-a to 90 kPa-a, or 50 kPa-a to 70 kPa-a. In other aspects, the pressure during desorption can be roughly ambient or higher. In such aspects, the pressure during desorption can be 90 kPa-a to 150 kPa-a, or 100 kPa-a to 150 kPa-a, or 110 kPa-a to 150 kPa-a.

Typically, the temperature during desorption will be different from the temperature during sorption. The pressure in the sorbent environment can also vary between sorption and desorption. Thus, some type of temperature adjustment and/or pressure adjustment can be performed after the sorption step, and another temperature adjustment and/or pressure adjustment can be performed after the desorption step. In some aspects, temperature adjustment between the sorption step and desorption step can be performed using the sweep gas for desorption as a heat transfer medium. In such aspects, the temperature at the beginning of the desorption step may be lower than the temperature at the end of the desorption step, as some time may be required for the sorbent environment to heat to the temperature of the sweep gas. In other aspects, heat exchange pipes can be incorporated into the sorbent environment, so that water (or another heat exchange fluid) at an appropriate temperature can be flowed into the pipes in the sorbent environment as a heat exchange fluid. For pressure adjustment, pressure decreases can be performed using a suitable pump, while pressure increases can be performed by flowing a gas at the target pressure into the sorbent environment until roughly the target pressure is reached.

In addition to optional temperature and/or pressure adjustment steps, purge steps can also optionally be incorporated into a sorption/desorption cycle. Purge steps can assist, for example, with maintaining separation between sorption and desorption, in order to improve purity of the effluent from the desorption step.

The cycle length for a sorption/desorption cycle can vary depending on a variety of factors. For input flows with relatively higher concentrations of a gas component for sorption, shorter cycle lengths for the sorption step can be appropriate, such as a sorption step length of 5.0 seconds to 60 minutes, or 5.0 seconds to 10 minutes, or 5.0 seconds to 1.0 minutes, or 1.0 minutes to 60 minutes, or 1.0 minutes to 10 minutes, or 10 minutes to 60 minutes. For sorption from a more dilute input flow where the gas component for sorption is present at a concentration of 100 vppm to 2500 vppm, or 100 vppm to 1000 vppm, such as sorption of CO₂ from air, longer sorption steps can be used to allow a greater percentage of the equilibrium capacity of the amine to be utilized. For the desorption step, the desorption step length can be 5.0 seconds to 100 minutes, or 5.0 seconds to 10 minutes, or 5.0 seconds to 1.0 minutes, or 1.0 minutes to 100 minutes, or 1.0 minutes to 10 minutes, or 10 minutes to 100 minutes.

The concentration of CO₂ in the input flow can vary depending on the type of process. For relatively dilute applications like separation of CO₂ from air (e.g., direct air capture), the CO₂ concentration in the input flow for the sorption step can be from 300 vppm to 1000 vppm, or 300 vppm to 650 vppm. It is noted that a typical CO₂ concentration for air is 400 vppm. In some other applications, a CO₂ concentration of 1.0 vol % to 7.5 vol % can be included in the input gas flow, or 1.0 vol % to 5.0 vol %, or 2.0 vol % to 7.5 vol %, or 2.0 vol % to 5.0 vol %. For example, a flue gas generated by a natural gas fired turbine can typically have a CO₂ content of roughly 4.0 vol %. In still other applications, the CO₂ content of the input gas flow for sorption can range from 1.0 vol % to 20 vol %, or 1.0 vol %, or 15 vol %, or 1.0 vol % to 10 vol %, or 5.0 vol % to 20 vol %, or 5.0 vol % to 15 vol %.

### Amine Sorbents

In order to perform a sorption/desorption cycle at reduced temperature and pressure, the sorbent material in the sorbent environment needs to be a sorbent that provides reasonable working capacity for sorption/desorption of a component in the target temperature range. Generally, the sorption step for CO₂ sorption by an amine can be performed at temperatures of −10 °C to 75 °C, while desorption can generally be performed at a temperature that is higher than the sorption temperature, with the desorption temperature being between 20 °C and 150 °C. In some aspects, additional benefits can be achieved if the sorption/desorption process can be operated with a sorption temperature of −10 °C to 25 °C and a desorption temperature of 20 °C to 80 °C, or 20 °C to 70 °C.

For a CO₂ sorption desorption cycle, one example of an amine that provides suitable working capacity is tetraethylenepentamine (TEPA), which can absorb CO₂ at roughly 25 °C and regenerate (desorb) at roughly 70 °C or higher. Other examples are 2-methoxy-n-methylbenzene (MMBA) and N,N-Bis[3-(methylamino)propyl]methylamine (BMMA), which both can absorb CO₂ at temperatures between −10 °C and 25 °C while allowing for regeneration at temperatures between 25 °C and 50 °C. In other aspects, amines that can be used include secondary amines that a) have a melting point and/or glass transition temperature that is below the sorption temperature (i.e., the secondary amine is a liquid at the sorption temperature), and b) have a vapor pressure of 0.02 kPa or less at 25 °C. Another example of a potential amine is monoethanolamine (MEA).

It is noted all of the above amines correspond to amines that are liquids in the temperature range where the sorption/desorption cycle occurs. However, in order to provide high contact area, it is beneficial to have high surface area solid sorbents. In order to obtain the favorable working temperature range of the amines while still providing a high surface area solid sorbent, a sorbent can be formed that corresponds to a solid with infused reactive liquids (SWIRL). By infusing an amine into a solid structure, a sorbent can be performed that provides the beneficial sorption/desorption properties of the liquid amine while also providing the higher surface areas that can be achieved by the solid support of the liquid.

In a SWIRL type sorbent structure, the infused liquid can correspond to an amine-based sorbent, such as to molecular compounds containing primary amines (R—NH₂), secondary amines (R—NH—R′), tertiary amines (R—N—R′), or mixtures of them. In some aspects involving direct air capture, a high concentration of secondary amine compounds in the liquid can be beneficial. Depending on the amine type, absorption and regeneration are typically performed at different temperatures, similar to existing solid sorbent technologies. However, some SWIRL type sorbent structures can allow for sorption/desorption cycles with substantially reduced temperatures during sorption and desorption and/or temperature differentials between sorption and desorption. For example, a SWIRL-TEPA sorbent (SWIRL with infused tetraethylenepentamine as the amine-based sorbent) can absorb CO₂ at Tₐ=25 °C while being regenerated at Tᵣ=70 °C. Some other amine liquids (such as MMBA and BMMA) can absorb CO₂ at Tₐ=(−10−25) °C and be regenerated at Tᵣ=25 °C or higher. It has been discovered that reducing the operating temperature and magnitude of the temperature swing between absorption and regeneration yields a significant reduction of the thermal energy requirements. This is significant as thermal costs can account for up to 80% of the overall operating energy consumption of a DAC facility. Another potential benefit of using low desorption temperatures is a reduced or minimized oxidation rate. In current solid sorbent technologies, residual air has to be removed with a vacuum pump between the absorption and regeneration stages to prevent oxidation while the monoliths are heated up to the regeneration temperature of 80 °C or higher. For SWIRL-amine structures that can desorb at 70 °C or less, amine oxidation is significantly reduced. For example, SWIRL-MMBA (SWIRL with infused 2-methoxy-n-methylbenzylamine) and SWIRL-BMMA (SWIRL with infused N,N-Bis[3-(methylamino)propyl]methylamine) can both be operated between −10 °C to 25 °C. Such low temperature swings can also reduce, minimize, or even eliminate the need of having a vacuum pump for residual air removal.

### Examples of SWIRL Structures

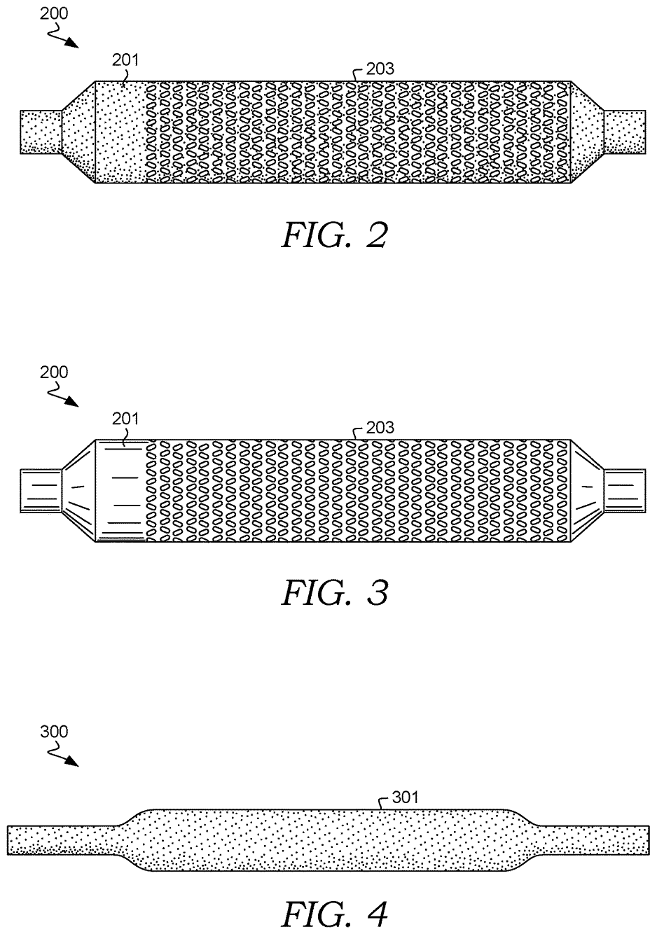

In various aspects, amine-based sorbents having a structure of a solid with infused reactive liquids (SWIRL) can be used for sorption/desorption cycles. FIGS. 2-4 show examples of a structure that can be used to form a solid with infused reactive liquid structure. Although the structures shown in FIGS. 2-4 are not in a disc shape, it is understood that the various types of structures can be formed that follow the principles described herein.

Referring to FIG. 2 and FIG. 3, a species extraction apparatus 200 can include a body 201 supporting a matrix structure 203. The matrix structure 203 comprises a plurality of surfaces that function to enhance uptake of the absorptive liquid and provide a complex, tortuous flow path for the working fluid. These features increase contact between the absorptive liquid and working fluid that is passed through the apparatus, and thus improve the efficiency of the species extraction apparatus 200.

In certain embodiments, the absorptive liquid is infused within at least a portion of the texture of the species extraction apparatus 200. This is referred to herein as a liquid infused surface, infused liquid, or the like. When the absorptive liquid covers the entire top surfaces of the textures, it is referred herein to as a liquid encapsulated solid, encapsulation, or the like. Both a liquid infused surface and a liquid encapsulated solid may be referred to herein as a liquid impregnated solid.

As shown in FIG. 2 and FIG. 3, the matrix structure 203 can be externally accessible. In other embodiments as shown in FIG. 4, the species extraction contactor 300 can contain the matrix structure within the body 301 such that it is only accessible internally. For example, as shown, the body 301 can form a pipe with an outer shell for channeling flow through the pipe. The outer shell can provide one or more benefits, in addition to the ease of operation, as no assembly is required when the entire structure is manufactured as one. For example, a tortuous path combined with the outer shell may greatly reduce potential bypass issues as no additional wrapping or loading of the cellular structure into a reactor or tube is required. Also, the contact of the cellular structure to the shell of the body 301 can provide a direct path for the conduction of heat that could be utilized to desorb the absorbed gas species from the supported absorptive liquid. Additionally, both the shell as well as the inside matrix structure are capable of providing the characteristics of a support structure for a liquid impregnated solid.

The species extraction apparatuses 200 and 300 can be configured to uptake an absorptive liquid disposed on the matrix structures. The absorptive liquid can be configured to remove at least one species from a working fluid that contacts the matrix structures. For example, embodiments can include suitable internal and external surface roughness, textures, or structural features to uptake a suitable amount of absorptive liquid (e.g., to produce CO₂ absorption in accordance with the tables below).

In some embodiments, the performance index (PI) of the apparatus is greater than 150.0 m⁻¹ or greater than 500.0 m⁻¹. PI is defined as PI=(V_{L}/V)(A_{L}/V). V_{L} and A_{L} are the volume and surface area of the impregnating/absorptive liquid, respectively. V_{L} may be determined by weighing the apparatus before and after applying the absorptive liquid, and then converting the mass difference (e.g., the mass of absorptive liquid held by the apparatus) into a volume using the density of the absorptive fluid. Where the absorptive liquid perfectly or nearly-perfectly wets all of the surfaces of the apparatus, A_{L} is essentially equal to S, the surface area of the apparatus. In such cases, S is substituted for A_{L} in the calculation of PI for simplicity. For purposes of the PI calculation herein, perfect or near-perfect wetting is presumed and thus S is used for A_{L} in the calculation of PI. The amount of absorptive liquid that the apparatuses disclosed herein uptake suggests that this assumption is reasonable. Systems with a PI greater than 150 m⁻¹ are more efficient, and thus can be smaller and less expensive than conventional systems.

Certain embodiments can include a surface treatment configured to chemically activate the surface to cause interaction with and/or wetting of the surface by the selected absorptive liquid. Any suitable chemical surface treatment or other treatment to cause wetting of the surface by the absorptive liquid is contemplated herein. Such an activated surface can greatly enhance uptake of the absorptive liquid.

In certain embodiments, the apparatus has a surface area to volume (S/V) ratio of greater than about 180 m⁻¹. In certain embodiments, the S/V ratio can be between 2500 m⁻¹ and 12500 m⁻¹.

In some aspects, the apparatus may include a plurality of cellular units, such as hex prism laves phase units, to form the matrix structure. For example, a plurality of cellular units can be formed in a vertical stack and/or formed next to each other laterally. Such cellular units can be stacked and/or placed adjacent to each other in any suitable manner. Any other suitable shape for the matrix structure is contemplated herein.

The matrix structure can be pretreated. For example, it may be calcined in air for a predetermined time and temperature. The matrix support structure can be calcined in air or other suitable fluid, at a temperature of above 150 °C, above 250 °C, or above 350 °C before the absorptive liquid is disposed thereon. This has been found to increase the uptake and performance of the absorptive liquid and thus improve the efficiency of absorption of the working fluid.

The apparatus can be made out of metal. Any other material suitable for the desired application is contemplated herein (e.g., ceramics, plastics). Additive manufacturing can include selective laser sintering (e.g., a metallic powder) at an energy density less than roughly 5.0 J/mm to increase roughness of the metallic body. The apparatus can be formed by additive manufacturing or “3D printing”. Any suitable 3D printing process can be used.

### Example—Calculation of Number of Modules for a Target Capacity and Module Size

The strategy used to calculate the number of modules can be explained with an example. In this example, the goal is to replace a larger, single sorbent module with a plurality of First, the modular design is selected so that the modular design does not affect the overall pressure drop of the bed. For example, using Darcy's law, to keep the pressure drop equal to 50 mbar across a single module with the permeability k≈1×10⁻⁸ m², the relationship between the velocity, u, and the length of the bed, L, can be written as

$$uL \approx 2 \frac{{m}^{2}}{s}$$

for a gas viscosity μ=2.7×10⁻⁵ Pa·s. The total cross-sectional bed area, A, can be evaluated as

$$A = \sqrt{\frac{QV}{uL}} .$$

Afterwards, the following steps can be used to determine the bed dimensions properties: i) Pick an approximate main channel diameter (that is practical with regard to manufacturing or desired footprint). ii) Calculate number of modules, N: Divide A by channel cross-section area calculated using the main channel diameter picked in previous step. Round up to allow for a gap between the channel and modules. iii) Calculate module diameter, h_{mod}=\sqrt{V/NπL}. iv) Verify pressure drop across each module is less than or equal to 50 mbar assuming uniform flow rate distribution. v) Calculate the flow rate distribution using the above resistor network model or CFD simulations, and, if necessary, re-adjust the exact channel diameter by changing the gap size, Δh=h_{channel}−h_{mod}.

Example: For a 1 MTa (MegaTons per annum) CO₂ capture rate from the flue gas of a Natural Gas Combined Cycle (NGCC) power plant, the total volumetric flow rate is

$$Q = 463 \frac{{m}^{3}}{s} ,$$

and the total bed volume is V=435 m³ using an absorption time lasting 5 minutes. Using

$$L = \sqrt{\frac{kV}{μ Q} Δ P} ,$$

each module is taken to be L=1.3 m long, which ensures the pressure drop to be equal to ~46 mbar. Following the steps i-iv listed above, the number of modules, module radius, velocity, and Reynold's number at the inlet can be calculated as a function of the main duct radius, h_{channel}/2. Step v is used to ensure equal flow distribution across the modules.

It is also noted that if further reduction of pressure drop and/or velocity is needed, increasing the number of modules of the same length provides the needed criteria. More specifically, if the number of modules increases by a factor of β the velocity will drop by the same factor and pressure drop decreases by factor of β².

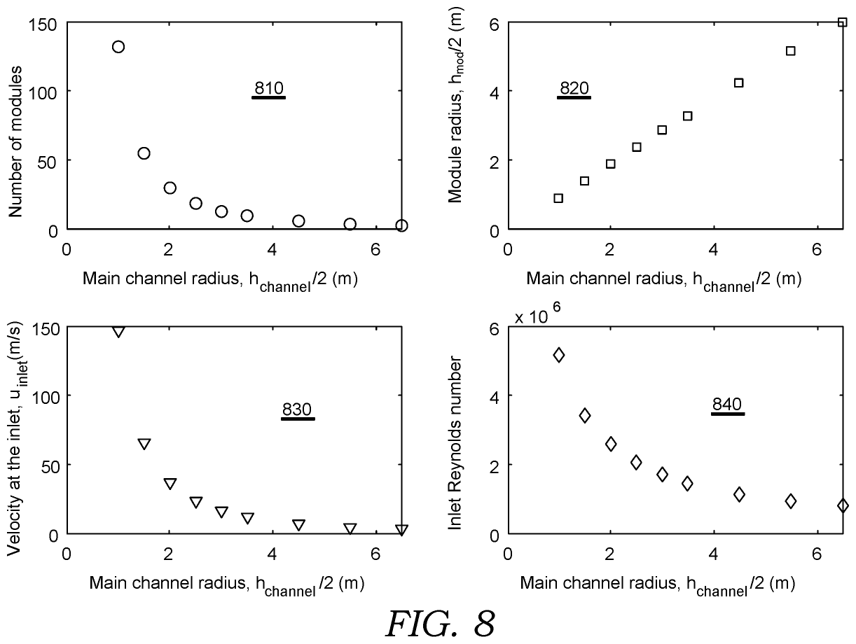

FIG. 8 shows various plots for the 1 MTa case with a 50 mbar pressure drop condition across each 2 m long module. The plots show how the flow parameters change as the size of the channel or vessel containing the sorbent beds is changed. A series of calculations were performed with various numbers of modules or beds. Plot 810 shows the number of beds used in each calculation, along with the corresponding radius for the channel or vessel that contains the beds. The number of modules ranges from 3 to 120. The data points in plots 820, 830, and 840 correspond to using the number of modules shown in plot 810. Plot 820 shows the corresponding radius of the modules. Plot 830 shows the corresponding velocity at the inlet to the channel or vessel, while plot 840 shows the Reynolds number at the inlet.

The plots in FIG. 8 show the flow parameters resulting in the desired 1 MTa capture rate as a function of main duct diameter, h_{channel}. With lower h_{channel}, the number of modules increases, while the module radius decreases. In order to sustain the desired capture and corresponding flow rate this leads to higher velocities at the inlet (as well as higher Reynolds numbers).

It is also important to note that the overall pressure drop between the inlet and the outlet of the enclosure channel remains below 50 mbar, as the pressure drop across the gap between the module and the channel wall is negligibly small. This is valid as long as there is a large enough gap to ensure equal flow distribution to each module.

### ADDITIONAL EMBODIMENTS

Embodiment 1. A system for exposing a gas flow to a networked plurality of sorbent modules, the system comprising: a vessel comprising at least one gas inlet, at least one gas outlet, a channel volume in fluid communication with the at least one gas inlet, and an exhaust volume in fluid communication with the at least one gas outlet, the channel volume having a channel cross-section height; a plurality of sorbent modules within the vessel, each sorbent module comprising a sorbent, each sorbent module having a module height that is less than the channel cross-section height, an inlet side of each sorbent module being in fluid communication with the channel volume, an outlet side of each sorbent module being in fluid communication with the exhaust volume, the plurality of sorbent modules comprising three or more sorbent modules; wherein a difference between the module height for a sorbent module and the channel cross-section height is a gap height, a ratio of the gap height for a sorbent module versus the module height for the sorbent module being from 0.0004 to 0.0133.

Embodiment 2. The system of Embodiment 1, wherein the channel volume has a substantially circular cross-section, or wherein the plurality of sorbent modules have a substantially circular cross-section, or a combination thereof.

Embodiment 3. The system of any of the above embodiments, wherein each sorbent module has substantially the same cross-section.

Embodiment 4. The system of any of the above embodiments, wherein each sorbent module has substantially the same height, or wherein each sorbent module has a thickness that is substantially the same, or a combination thereof.

Embodiment 5. The system of any of the above embodiments, wherein the plurality of sorbent modules comprises 3 to 12 sorbent modules.

Embodiment 6. The system of any of the above embodiments, wherein the channel volume is in indirect fluid communication with the exhaust volume via the plurality of sorbent modules, and wherein the exhaust volume is not in fluid communication with the channel volume within the vessel.

Embodiment 7. The system of any of the above embodiments, wherein the sorbent comprises an amine sorbent.

Embodiment 8. The system of any of the above embodiments, wherein each sorbent module in the plurality of sorbent modules independently comprises a SWIRL structure, a packed bed of sorbent particles, a sorbent supported on one or more monoliths, a porous polymeric sorbent, or a combination thereof.

Embodiment 9. The system of any of the above embodiments, wherein the exhaust volume comprises a plurality of separate exhaust channels, the outlet side of each sorbent module being in fluid communication with at least one exhaust channel of the plurality of separate exhaust channels.

Embodiment 10. A method for exposing gas flows to a plurality of sorbent modules, the method comprising: passing a gas flow comprising a first component into a system according to any of Embodiments 1 to 9.

Embodiment 11. The method of Embodiment 10, wherein a ratio at steady state of gas flow through the sorbent bed with the lowest gas flow relative to gas flow through the bed with the highest gas flow is 0.9 or higher.

Embodiment 12. The method of claim 10 or 11, wherein the first component is CO₂.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

We claim:

1. A system for exposing a gas flow to a networked plurality of sorbent modules, the system comprising:
a vessel comprising at least one gas inlet, at least one gas outlet, a channel volume in fluid communication with the at least one gas inlet, and an exhaust volume in fluid communication with the at least one gas outlet, the channel volume having a channel cross-section height;
a plurality of sorbent modules within the vessel, each sorbent module comprising a sorbent, each sorbent module having a module height that is less than the channel cross-section height, an inlet side of each sorbent module being in fluid communication with the channel volume, an outlet side of each sorbent module being in fluid communication with the exhaust volume, the plurality of sorbent modules comprising three or more sorbent modules;
wherein a difference between the module height for a sorbent module and the channel cross-section height is a gap height, a ratio of the gap height for a sorbent module versus the module height for the sorbent module being from 0.0004 to 0.0133.

2. The system of claim 1, wherein the channel volume has a substantially circular cross-section, or wherein the plurality of sorbent modules have a substantially circular cross-section, or a combination thereof.

3. The system of claim 1, wherein each sorbent module has substantially the same cross-section.

4. The system of claim 1, wherein each sorbent module has substantially the same height, or wherein each sorbent module has a thickness that is substantially the same, or a combination thereof.

5. The system of claim 1, wherein the plurality of sorbent modules comprises 3 to 12 sorbent modules.

6. The system of claim 1, wherein the channel volume is in indirect fluid communication with the exhaust volume via the plurality of sorbent modules, and wherein the exhaust volume is not in fluid communication with the channel volume within the vessel.

7. The system of claim 1, wherein the sorbent comprises an amine sorbent.

8. The system of claim 1, wherein each sorbent module in the plurality of sorbent modules independently comprises a SWIRL structure, a packed bed of sorbent particles, a sorbent supported on one or more monoliths, a porous polymeric sorbent, or a combination thereof.

9. The system of claim 1, wherein the exhaust volume comprises a plurality of separate exhaust channels, the outlet side of each sorbent module being in fluid communication with at least one exhaust channel of the plurality of separate exhaust channels.

10. A method for exposing gas flows to a plurality of sorbent modules, the method comprising:
passing a gas flow comprising a first component into a gas inlet of a vessel containing a networked plurality of sorbent modules, a channel volume of the vessel having a channel cross-section height, an inlet side of each of the plurality of sorbent modules being in fluid communication with the channel volume, an outlet side of each sorbent module being in fluid communication with an exhaust volume, each sorbent module comprising a sorbent, each sorbent module having a module height that is less than the channel cross-section height, the plurality of sorbent modules comprising three or more sorbent modules;
passing at least a portion of the gas flow through each sorbent module of the plurality of sorbent modules to form a plurality of module output flows in the exhaust volume,
wherein a difference between the module height for a sorbent module and the channel cross-section height is a gap height, a ratio of the gap height for a sorbent module versus the module height for the sorbent module being from 0.0004 to 0.0133.

11. The method of claim 10, wherein a ratio at steady state of gas flow through the sorbent bed with the lowest gas flow relative to gas flow through the bed with the highest gas flow is 0.9 or higher.

12. The method of claim 10, wherein the channel volume has a substantially circular internal cross-section, or wherein the plurality of sorbent modules have a substantially circular cross-section, or a combination thereof.

13. The method of claim 10, the each sorbent module has substantially the same cross-section.

14. The method of claim 10, wherein each sorbent module has substantially the same height, or wherein each sorbent module has a thickness that is substantially the same, or a combination thereof.

15. The method of claim 10, wherein the plurality of sorbent modules comprises 3 to 12 sorbent modules.

16. The method of claim 10, wherein the plurality of module output flows do not mix with the gas flow in the interior volume of the vessel.

17. The method of claim 10, wherein the first component is CO₂.

18. The method of claim 10, wherein the sorbent comprises an amine sorbent.

19. The method of claim 10, wherein each sorbent module in the plurality of sorbent modules independently comprises a SWIRL structure, a packed bed of sorbent particles, a sorbent supported on one or more monoliths, a porous polymeric sorbent, or a combination thereof.

20. The method of claim 10, wherein the exhaust volume comprises a plurality of separate exhaust channels, the outlet side of each sorbent module being in fluid communication with at least one exhaust channel of the plurality of separate exhaust channels.
